(19) United States
(12) Patent Application Publication
(10) Pub. No.: US 2007/0084989 A1
(43) Pub. Date: Apr. 19, 2007

(54) Light guide touch screen

(75) Inventors: Ruediger Johannes Lange, Heerlen (NL); Volker Schoellmann, Dusseldorf (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/572,624

(22) PCT Filed: Sep. 14, 2004
(86) PCT No.: PCT/IB04/51747

§ 371 Date: Mar. 17, 2006

(30) Foreign Application Priority Data
Sep. 22, 2003 (EP) 03103488.7

(51) Int. Cl. G06M 7/00; H01J 40/14

(52) U.S. Cl. 250/221

(57) ABSTRACT

The present invention relates to a display device with a detection system for detecting an input po- sition on a screen (301) of the display. A light guide (302) is arranged adjacent to the screen (301). The light guide (302) has a light source (308) arranged to emit light (310) into the light guide (302). The optical matching between the light guide (302) and its surroundings is adapted such that the light (310) of the light source (308) is normally confined within the light guide (302) by means of total internal reflection. However, a user establishing physi- cal contact with the light guide (302) perturbs the state of total internal reflection, and light (310) will be extracted from the light guide (302). In the display device, light detecting means (303) are arranged to detect said light (310) and relate this detection to an input position where the user contact occurred. The display is preferably an LCD, O-LED or P-LED type display.

The present invention relates to a coordinate detection system for a display device.

To improve the interactivity between users and computers, touch screen displays have been introduced for multimedia information kiosks, educational centers, vending machines, video games etc. A touch screen display is a display screen which can be affected by physical contact, allowing a user to interact with the computer by touching icons, pictures, words or other visual objects on the computer screen. Touching, i.e. establishment of physical contact with the screen at an input position, is usually done with a finger, a pen to prevent the screen from becoming dirty and stained or some other appropriate stylus.

A versatile touch screen is generally independent of the type of display or touch area The touch screen should allow different resolutions, from pixel level resolution for a pen input to input using a finger or any other relatively large object, and different sizes, ranging from mobile phone displays to advertising boards. The touch screen shall further be independent of the surrounding illumination, electric fields, stray capacitances etc.

Japanese Patent application no. 11-273293 discloses a touch panel, a display device equipped with a touch panel and electronic equipment equipped with a display device. A light guide plate is illuminated by lighting means. The light of the lighting means, incident from two sides of the light guide plate, impinges on optical sensors located on the opposite side of the light guide plate, with respect to the lighting means. The light is totally reflected in the light guide plate and coupled out of the light guide when the surface of the light guide plate is touched by an input pen or finger tip, resulting in the fact that the light quantity on the optical sensors is decreased. The input position on the touch panel can thus be detected.

In this prior art, to achieve detection of an input position by employing the touch screen, a reduced light intensity on the optical sensors is detected since the light in the light guide plate is refracted in a direction away from the sensors.

This requires the construction of a sensor array at the edges of the light guide and thus of the display device, generally located on the opposite side of the lighting means. As a result, the display device becomes more bulky, since it is not possible to place or integrate the sensors in any of the existing substrates arranged in the display device.

It is an object of the present invention to provide a compact display device with a touch screen, including a light guide. This object is attained by a display device according to claim 1. Preferred embodiments are defined by the dependent claims.

According to an aspect of the invention, a display device including a display is provided with a system for detecting an input position on a display screen of said display. Thus, the display screen constitutes a touch screen, with which a user can interact. The coordinate on the screen where the user interaction occurs is referred to as ‘input position’ hereinafter.

The detection system comprises a light guide arranged adjacent to the screen. The light guide has a light source arranged to emit light into the light guide. Preferably, the light guide has a light source, e.g. a LED or some other diffuse light source, arranged at one side of the guide to emit light into the light guide.

The light guide is optically matched with its surroundings in such way that the light of the light source is normally confined within the light guide by means of total internal reflection. ‘Normally’ in this context should be understood to refer to the situation that no user interaction takes place. For example, the refractive index of the light guide may be higher than that of its surroundings.

When a user of the display device establishes physical contact with the display screen, by means of a finger, a pen or some other pointer object, the state of total internal reflection of the light inside the light guide is perturbed, and as a result light is extracted from the light guide and preferably directed away from the screen, that is in a direction substantially away from the user/viewer.

The display device comprises light detecting means in the form of e.g. photo detectors to detect the light which is extracted from the light guide. This is advantageous, since the light detecting means can be arranged in the plane of the display screen itself, rather than at its edges. This leads to a display device which is reduced in size.

The light detecting means are arranged for relating an event of detecting light which is extracted from the light guide to an input position where user interaction took place (the point of contact on the display screen). Preferably, the light detecting means comprise a plurality of photo sensors or photo detectors associated with different input position on the touch screen. Preferably, each one of the photo sensors or photo setectors is associated with a single input position or an input area (button) on the display screen. For example, a plurality of photo sensors or photo detectors may be provided, one for each picture element of the display.

The present invention is advantageous, since reliable detection of incident light can be provided in most types of displays, such as LCD, CRT, different type of LED technologies, e.g. OLED, PLED etc. Devices in which the present invention can be applied include mobile phone screens, different types of monitoring devices, television sets, projection screens etc. The fact that the light which is totally reflected in the light guide is extracted from the light guide and directed into the display device when a user establishes contact with the touch screen is advantageous, since the light detecting means can preferably be integrated in any of the substrates in the display, i.e. in the plane of the display, wherein a smooth, integrated light detecting solution is provided.

According to an embodiment of the invention, the display device comprises an active matrix display and the light detecting means are preferably integrated in the active matrix substrate of the display device. For example, the display device comprises an active matrix liquid crystal display (AM-LCD), active matrix organic LED display (AM-OLED) or active matrix polymer LED display (AM-PLED).

In this embodiment, the light detecting means preferably comprises the thin film transistors (TFTs) of the active matrix substrate. A characteristic of the semi-conducting materials forming the TFTs is photo electricity, which means that a photo-induced leakage current is induced in a TFT, when the TFT is exposed to light. Therefore, the TFTs in for example conventional liquid crystal displays are shielded from any incident light by means of a light-rejecting layer.

By making an opening in the layer or by replacing the layer with a layer of another material which is opaque to a specified wavelength, the TFTs can now deliberately be made sensitive to external light (of a specified wavelength). This embodiment has the advantage that a smooth, integrated solution can be provided, since the existing TFTs can be used as photo detectors and, thus, there is no need to use additional photo detectors in the system. This allows the construction of a particlarly compact display device with touch screen.

Alternatively, the display device comprises a photo sensitive substrate arranged to detect the light which is extracted from the light guide and directed into the display device. This alternative embodiment also provides an integrated solution, and detection can be provided in the plane of the display. Different areas associated with the input positions on the touch screen should then preferably be defined within the photo sensitive substrate, so as to be able to relate a light detection event in the photo sensitive substrate to an input position of the display screen.

According to yet another embodiment of the invention, the light guide is arranged in the front plate of the display device. This has the advantage that an additional light guide need not be arranged on the exterior face of the display device, but the existing display front plate can be employed as a light guide. Integrating the light guide in the actual display front plate makes the display device even more compact.

According to yet another embodiment of the invention, the light source arranged to emit light into the light guide emits infrared light. This has the advantage that the light source arranged at one side of the guide to emit light into the light guide does not cause deterioration of the viewing properties of the display, since the IR light is not visible to the human eye, and permits use of silicon photo detectors.

According to another embodiment of the invention, an optical filter is arranged on the light detecting means to increase the selectivity for light incident on the light detecting means. For monochromatic light, the optical filter enhances the selectivity for the light. Selectivity can be required to distinguish the light impinging on the light detectors from ambient light. The light detectors and/or the optical filters should, in case the light source is of the pulsing type, be adapted to handle the pulsing light by means of synchronization with the pulsed light and/or by means of the optical filters being arranged to pass only the bandwidth of interest.

Further features of, and advantages with, the present invention will become apparent when studying the appended claims and the following description. Those skilled in the art realize that different features of the present invention can be combined to create embodiments other than those described in the following.

The present invention will be described in detail, with reference made to the accompanying drawings, in which:

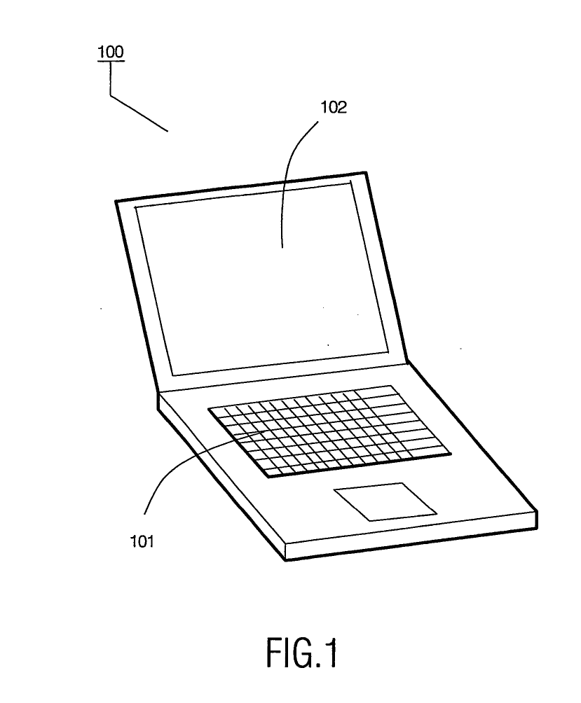

FIG. 1 shows an example of a prior art display device in which the present invention can be applied;

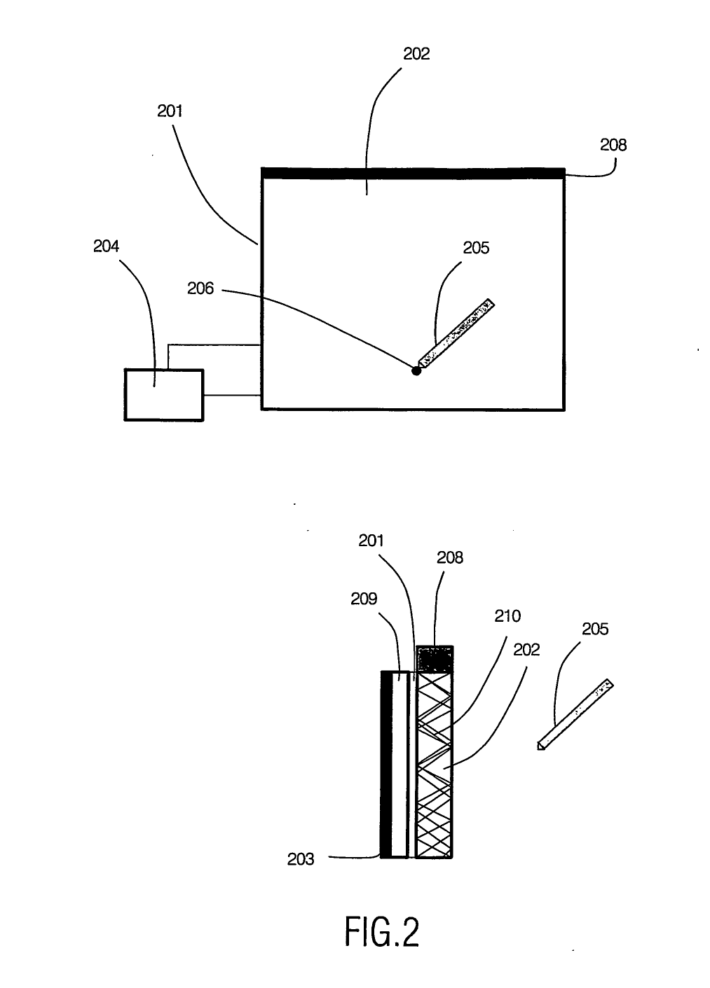

FIG. 2 shows a schematic front view and a side view of a display device screen on which a light guide is arranged in accordance with an embodiment of the present invention;

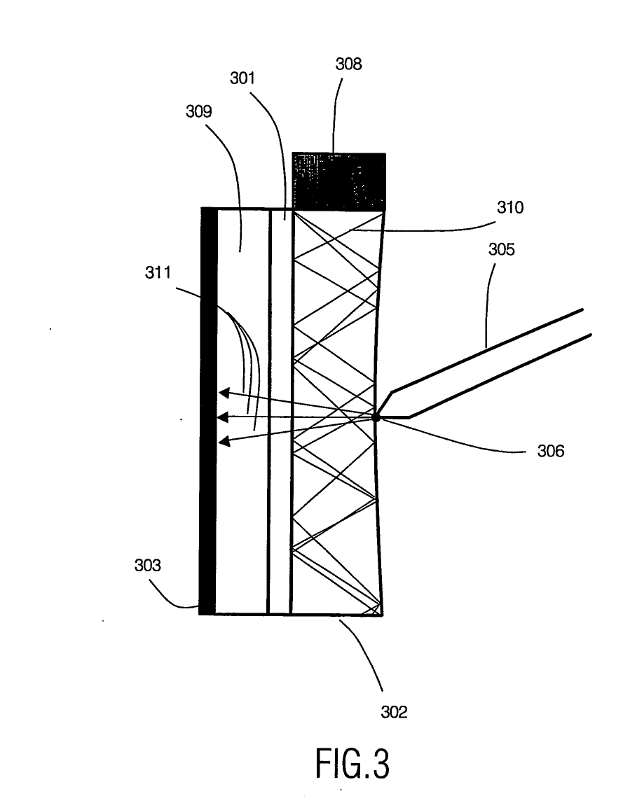

FIG. 3 shows a side view of a light guide for which the total internal reflection is perturbed;

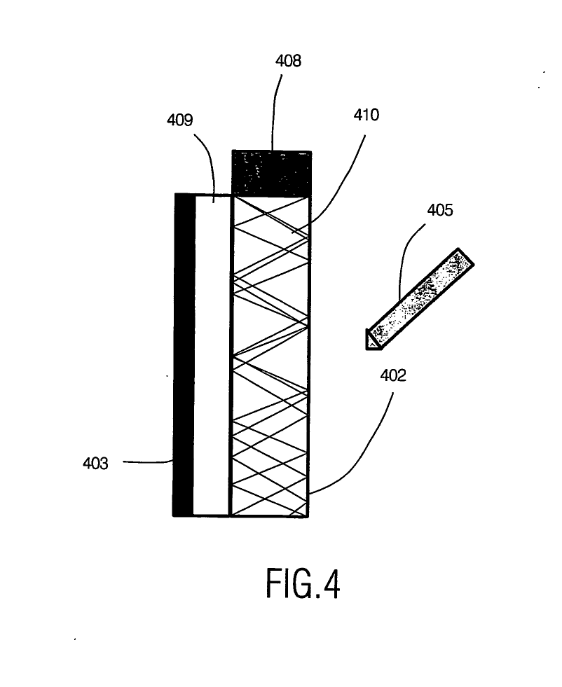

FIG. 4 shows a side view of the light guide arranged in the display front plate of a screen; and

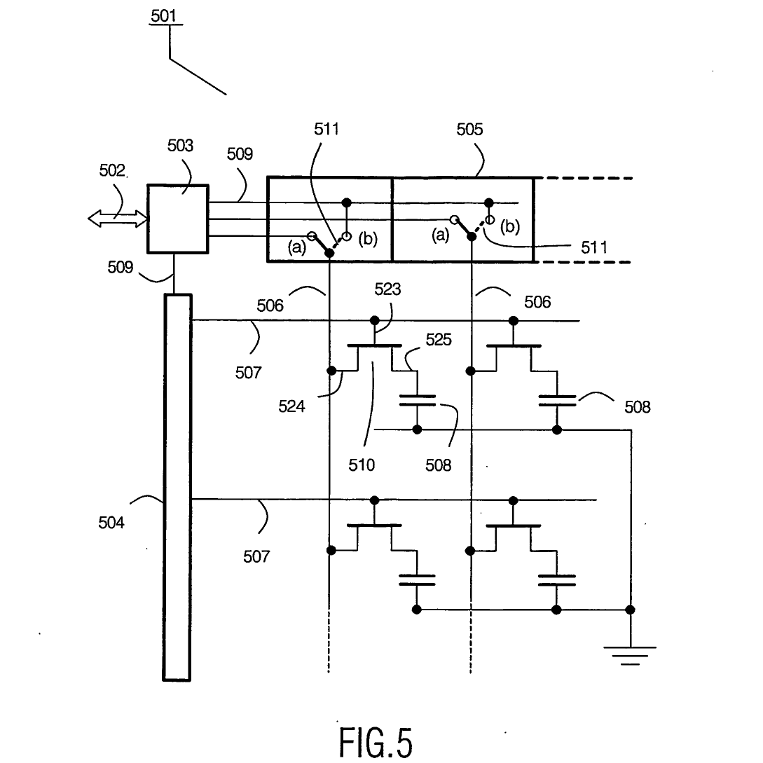

FIG. 5 shows a schematic view of a part of a display device to which the present invention is applicable.

FIG. 1 shows a display device 100 in the form of a laptop arranged with a keyboard 101 and an LCD flat screen 102, in which display device the present invention advantageously can be applied. The coordinate detection system according to the present invention comprising a light guide and light detecting means can be arranged in the display device in a number of different ways, as will be described. For example, the light guide can be arranged at the exterior of the display device, or preferably, in the front plate of the display device 100. The light detecting means are, as will be described in the following, preferably arranged in the interior of the display device.

The upper portion of FIG. 2 shows a schematic front view of a display device screen 201, on which a light guide 202 is arranged by means of adhesive or alternatively, the light guide is arranged in the front plate of the display device. Light detecting means 203 (not shown in the upper portion of FIG. 2) can be arranged in any of the substrates in the display device, i.e. in the plane of the display, wherein a smooth, integrated light detecting solution is provided. The light detecting means are connected to a CPU 204 or some other appropriate means having processing capabilities. Typically, the CPU comprises the existing processing means in the device in which the coordinate detection system is applied, the device being for example a laptop, a mobile phone, a projection screen, a television set etc. A pointing device in the form of a pen 205 is employed by a user to establish contact 206 with the screen.

The lower portion of FIG. 2 shows a schematic side view of the display device screen 201. The light detecting means 203 in the form of thin film transistors (TFTs) are integrated in the active matrix substrate 209 of the display device to detect incident light. The light guide 202 has a light source 208 arranged to emit light into the light guide. The optical matching between the light guide 202 and its surroundings is adapted such that the light 210 of the light source 208 is confined within the light guide by means of total internal reflection. Note that the light detecting means 203 not necessarily comprise TFTs. It is possible that the substrate 209 is composed of a photo sensitive material arranged to detect the light which is extracted from the light guide 202 and directed into the display device.

FIG. 3 shows a side view of the screen 301. Physical contact with the light guide 302 by means of, for example, a pen 305 perturbs the total internal reflection, whereby light 310 is emitted from the light source 308 via the light guide 302 to the light detecting means 303 (TFTs, photo sensitive plates etc.) in the active matrix substrate 309. When the state of total internal reflection is perturbed and light is extracted from the light guide 302 and directed towards the light detecting means 303, it is possible to determine the point 306 of contact on the display by determining the point(s) of incidence of light 311 impinging on the light detecting means 303 from the light source via the light guide. At the point 306 of contact, light 311 is scattered in multiple directions. In other words, it can be said that the point 306 of contact acts as a light source which emits the light 311. FIG. 3 shows a simplified view of this scattering which generally occurs in a great number of directions. For optical input, the light guide 302 is transparent and the light input will pass through the light guide and be detected in the light detecting means 303.

In FIG. 4, the light guide 402 is arranged in the front plate of the screen, thus making the coordinate detection solution even more compact.

FIG. 5 shows a schematic view of a part of a display device 501 to which the present invention is applicable. It comprises a matrix of elements or pixels 508 at the areas of crossings of row or selection electrodes 507 and column or data electrodes 506. The row electrodes are selected by means of a row driver 504, while the column electrodes are provided with data via a data register 505. To this end, incoming data 502 are first processed, if necessary, in a processor 503. Mutual synchronization between the row driver 504 and the data register 505 occurs via drivelines 509.

Signals from the row driver 504 select the picture electrodes via thin film transistors (TFTs) 510 whose gate electrodes 523 are electrically connected to the row electrodes 507 and the source electrodes 524 are electrically connected to the column electrodes. The signal which is present at the column electrode 506 is transferred via the TFT to a picture electrode of a pixel 508 coupled to the drain electrode 525. The other picture electrodes are connected to, for example, one (or more) common counter electrode(s). The data register 505 also contains switches 511 by which either incoming data can be transferred to the column electrodes 506 (situation 511a), or during a sensing stage, the status of TFTs 510 can be sensed (situation 511b of the switches 511).

A characteristic of semi-conducting materials is photo electricity, which means that a photo-induced leakage current is induced in a TFT 510, when the TFT is exposed to light. Therefore, the TFTs in conventional displays are shielded from any incident light by a light-rejecting layer (not shown), such as a black-matrix layer. By making an opening in the light-rejecting layer or by replacing the light-rejecting layer with a layer of another material which is opaque to a specified wavelength, the TFTs can be made sensitive to external light (of a specified wavelength).

A light beam may illuminate a TFT 510 locally, and the voltage stored on the capacitor 508 related to the TFT drops on illumination. Sensing of this voltage drop (situation 511b of the switches 511) before writing new information during a next write cycle enables distinguishing between an intentionally illuminated pixel and a non-illuminated pixel. The sensed information is stored in processor 503 and by using dedicated software, the point of incidence of light impinging on the display from the display device exterior can be detected. Many different alterations, modifications and combinations of the described embodiments will become apparent for those skilled in the art. The described embodiments are therefore not intended to limit the scope of the invention, as defined by the appended claims.

1. A display device, including a display, arranged for detecting an input position on a screen (301) of said display,
wherein the screen (301) comprises a light guide (302) and a light source (308) arranged to emit light (310) into the light guide (302), the light guide (302) being optically matched with its surroundings in such way that the light (310) emitted from said light source (308) is confined within the light guide (302) by means of total internal reflection, and is extracted from the light guide (302) when a user establishes physical contact with said screen (301) at said input position,
the display device further comprising a light detecting means (303) for detecting the light extracted from the light guide (302) and relate the detecting of said extracted light to said input position.

2. A display device as claimed in claim 1, wherein the light detecting means comprises a plurality of photo sensors or photo detectors associated with different input positions on the screen (301) of the display.

3. A display device as claimed in claim 1, wherein the light detecting means (303) is integrated with a substrate of the display.

4. A display device as claimed in claim 3, wherein the display is an active matrix type display (301).

5. A display device as claimed in claim 4, wherein the substrate is provided with thin film transistors (510) associated with picture elements of the display screen (301), the light detecting means (303) including said thin film transistors (510).

6. A display device as claimed in claim 1, wherein the light guide (302) is optically matched with the screen (301).

7. A display device as claimed in claim 1, wherein the light guide (402) is integrated with a front plate of the display device.

8. A display device as claimed in claim 1, wherein the light source (308) arranged to emit light into the light guide (302) emits light in the infrared range.

9. A display device as claimed in claim 1, wherein the light detecting means (303) are provided with an optical filter to increase the selectivity for light extracted from the light guide (302).
